(19) United States
(12) Patent Application Publication
(10) Pub. No.: US 2007/0050738 A1
(43) Pub. Date: Mar. 1, 2007

(54) Customer designed interposer

(76) Inventor: Larry E. Dittmann, Middletown, PA (US)

Correspondence Address: Neoconix;c/o Intellevate, P.O. Box 52050, Minneapolis, MN, 55402, US

(21) Appl. No.: 11/215,004

(22) Filed: Aug. 31, 2005

(51) Int. Cl. G06F 17/50

(52) U.S. Cl. 716/5

(57) ABSTRACT

A method and system that provides a customer with the ability to design an electrical connector (interposer) that is individualized to the customer's particular application requirements. An interface to a design program providing a plurality of design options is provided to the customer to aid in designing an interposer. A menu is provided from which a customer can design an array interposer by selecting specific contact types and designating the position of each contact type within an array. The finished customer order including a design for the array interposer is sent to a fabricator and manufactured based on the unique design provided by the customer.

### BACKGROUND

1. Field of the Invention

This invention relates to custom design of electrical components, and in particular to customer-designed electrical connectors that can be individualized to customer application requirements.

2. Background of the Invention

Conventional electrical connectors such as array interposers (or “interposers”), are used to connect components such as printed circuit boards. Interposers are fabricated using a wide variety of techniques. A common fabrication process employs stamped metal springs, which are formed and then individually inserted into an insulating carrier to form an array of electrical connection elements. Other interposer fabrication approaches include using anisotropically conductive adhesives, injection molded conductive adhesives, bundled wire conductive elements, and small solid pieces of metal.

As the desire for device performance enhancement drives packaging technology to shrink the spacing (or “pitch”) between electrical connections (also referred to as “leads”), a need exists to shrink the size of individual connector elements. At the same time, the total number of connections per package is increasing. For example, existing integrated circuit (IC) packages may be built with a pitch of 1 mm or less, having 600 or more connections. Furthermore, IC devices are designed to be operated at increasingly higher frequencies. For example, IC devices for use in computing, telecommunication, and networking applications can be operated at a frequency of several GHz. Operating frequencies of the electronic devices, package size, and lead count of the device packages thus place stringent requirements on the interconnect systems used to test or connect these electronic devices.

In particular, the mechanical, electrical, and reliability performance criteria of an interconnect system are becoming increasingly demanding. Electrical and mechanical reliability specifications for use with high speed, small dimension and large pin count IC devices can place requirements that conventional interconnect technologies described above cannot easily fulfill. In general, conventional connector systems optimized for electrical performance may have poor mechanical and reliability properties, while connector systems optimized for mechanical performance and improved reliability may have poor electrical characteristics.

One manner of addressing the above tradeoffs is to tailor the properties of individual units, such as individual spring elements, or groups of units, within an interposer array. For example, connections within one portion of an interposer may function better if they possess a different spring force, or operate at a higher frequency, or have a higher power carrying capability, than counterparts located in a different portion of the interposer array.

A common feature of all the above conventional interposer fabrication processes, however, is that the fabricated interposer arrays have a uniform set of features throughout the array. For example, a stamped spring array might have a set of uniformly spaced 2 mm diameter stamped springs arranged in a square array. In addition, in choosing interposer arrays for a given customer need, the customer is typically limited to a set of standard array elements and array layouts completely determined by the supplier.

### DESCRIPTION OF THE DRAWINGS

FIG. 1 depicts a system for fabricating interposers according to one configuration of this invention.

FIG. 2 illustrates exemplary aspects of a custom interposer fabricator, according to one configuration of the invention.

FIG. 3 illustrates a customer interface, arranged according to one configuration of this invention.

FIG. 4 depicts an exemplary page of a program for customer designing interposer arrays, according to one configuration of the invention.

FIG. 5 depicts an exemplary selection page providing design options for custom array design using the program of FIG. 4.

FIG. 6 depicts an exemplary work page of the program of FIG. 4, providing an array grid for a customer's interposer design.

FIG. 7 depicts a web page containing an exemplary customer-designed array drawing, according to one aspect of the invention.

FIG. 8 depicts an exemplary design confirmation page of the program of FIG. 4.

FIG. 9 shows exemplary steps involved in a process for formation of an interposer according to one aspect of this invention.

### DETAILED DESCRIPTION

Distinguishing features of this invention include a system and method that provides customer-designed electrical interposers having tailorable properties. As used herein, the terms “interposer” or “electrical interposer” refer to components that include a plurality of contacts. In some configurations of the invention, the contacts of the interposer may be used to temporarily or permanently electrically connect two or more other components disposed, for example, on opposite sides of the interposer. In other configurations of the invention, an “interposer” is a component having electrical contacts that are used to contact other components disposed on a single side of the interposer.

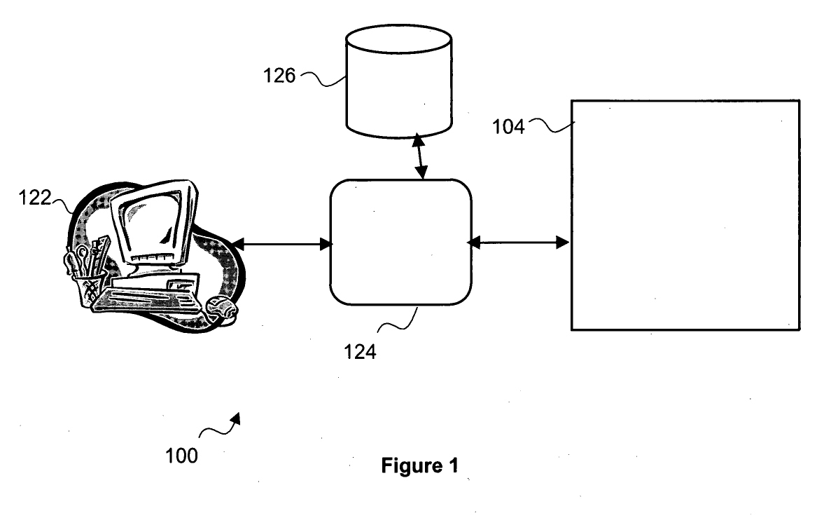

FIG. 1 depicts a system 100 for fabricating interposers according to another configuration of this invention. System 100 includes a customer interface 122 that provides a customer with access to interposer design capability. Preferably, as illustrated in FIG. 1b, customer interface 122 is a computer user interface that is coupled to a design program 124. Customer interface 122 can be, for example, a website of an interposer vendor or manufacturer, which is accessed through a computer or other web access device. Alternatively, customer interface 122 could be any visual or verbal display used in conjunction with design program 124 to allow a user to produce an interposer design. As such, customer interface 122 could be part of or incorporate a design program that is provided by an interposer vendor and stored locally on a computer or other device that has a display and memory, for example. Design program 124 is preferably a graphical based design program operable on computers or other data manipulating devices and capable of displaying salient features of interposer arrays to the customer, and providing a means for manipulating the interposer features as desired. In one example, interface 122 can constitute a “portal” web page that provides a customer access to design program 124 that is embodied in a series of web pages that can be modified by receiving customer input after interface 122 is accessed and design program 124 is activated.

In an exemplary configuration, design program 124 allows a customer to select interposer features from a predetermined set of pre-stored design features stored in design library 126, and to arrange those interposer features into a customer-designed interposer array tailored to the customer's needs. Preferably, the customer-designed interposer array is configured in graphical form that provides for convenient visual inspection and alteration by a user during operation of design program 124. The customer-designed interposer array so constructed (not shown) can then be saved as a digital file or set of files and/or be sent to the interposer vendor as an order for manufacturing of the customer-designed interposer array. In one configuration, the customer-designed interposer file is forwarded by design program 124 to interposer fabricator 106 for manufacturing.

In one configuration, interposer design library 126 contains various user-selectable features of a customer-designed interposer. Design library 126 can exist as a stand alone database stored in a convenient electronic, or magnetic, or other medium. Alternatively, design library 126 can be embedded or otherwise linked to design program 124. A user linking to design program 124 through interface 122, is provided with a menu of user-selectable features derived from library 126. For example, library 126 can contain a predetermined set of interposer contact designs (also referred to herein as “contact types”) for contact elements, from which the customer can select to build the customer's interposer; a predetermined set of array grid spacings and overall array dimensions for arrays in which the contacts are to be placed; and a predetermined set of interposer types and thicknesses for interposer substrates available for the customer-designed interposer. Using program 124, for example, the content of library 126 can be provided to the user in a series of discrete menus, where each menu is dedicated to one or more specific features of the interposer to be custom designed. Each discrete menu, in turn, may be provided to the customer as a distinct web page, or several menus can be located on a single page.

In one configuration of the invention, a customer-designed interposer array is represented as a set of outputs generated by program 124 that specify the user-determinable features of the interposer array. The set of outputs can then be stored for example, as a digital file that is used by the interposer array manufacturer to produce the customer-designed interposer array.

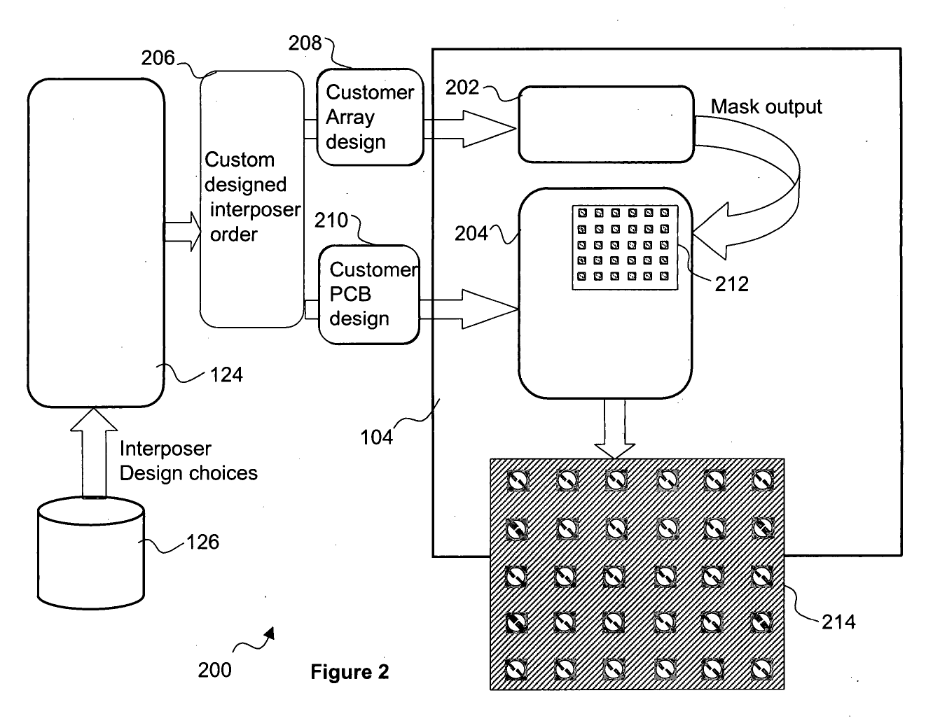

FIG. 2 illustrates exemplary aspects of a customer-based interposer fabrication system 200, according to one configuration of the invention. Interposer fabricator 104 can include, for example, interposer array mask generator 202, and interposer fabrication line 204. Line 204 can further include a spring element pattern process (not shown), spring element formation process (not shown), and other processes. In one aspect of the invention, fabricator 104 receives a custom-designed interposer order 206 containing a file with customer specified interposer array design 208 and customer interposer substrate design 210, among other possible user-determinable features.

Interposer array design 208 received in interposer order 206 can be used to generate an interposer array mask 212 in generator 202. For example, a direct write lithography tool can be used as generator 202. Direct write tools are often used to generate a physical mask that can be used multiple times to expose lithographically sensitive layers deposited on multiple substrates with the same pattern. When a lithographically sensitive layer is exposed to light passing through interposer array mask 212, contact array design 208 is transferred into that layer. Thus, interposer array mask 212 could be used to fabricate many interposer arrays having the same customer designed pattern. One aspect of this invention involves fabrication of interposer contacts by defining the spring element features that make up the contacts using lithographic patterning and etching of a metallic layer. The spring element features are further processed to produce three dimensional contacts arranged in an array as defined by interposer array mask 212. In one configuration of the invention, the metallic layer is a stand alone metallic spring sheet that is patterned to make two dimensional contacts and joined to an insulating substrate to form an interposer. In one configuration, before joining of the metallic sheet to the insulating substrate, the two dimensional contacts are formed into three dimensional contacts as described further below.

After a custom designed interposer mask 212 is fabricated, a spring element pattern process operates to pattern a metallic layer, such as a selected spring element sheet (also not shown) based on customer design received. In the example shown, interposer mask 212 is generated in mask generator 202 and then subsequently used in interposer fabrication line 204 to pattern the metallic layer. In an exemplary configuration, interposer fabrication within fabrication line 204 involves several process steps (not shown) including fabrication of an array of heterogeneous contacts of the interposer. This is accomplished by lithographic patterning using mask 212 to define an interposer array pattern in a lithographic medium disposed on a surface of a spring sheet, as well as etching of the spring sheet through the patterned lithographic medium to define the contact array elements of the interposer and overall contact array pattern.

Alternatively, after customer array design 208 is received, the array design can be used to generate a patterning process using a known direct write lithography process that does not involve generation of a physical mask. For example, instead of patterning a physical mask with the customer designed array pattern, a direct write tool can be used to directly transfer the customer designed array pattern into a lithographically sensitive medium that coats a spring sheet. In the latter case, for the purposes of simplicity, the “interposer array mask” is deemed to correspond to a program or set of data that resides in a direct write lithography tool, and is used to cause the tool to expose a lithographically sensitive medium disposed on a spring sheet with the same array design pattern that would be embodied in a physical mask. In either case, using a direct write patterning or using a physical mask-based lithographic process, the same contact pattern based on customer array design 208 is transferred into a spring sheet.

Further process steps taking place within fabrication line 204 can include formation of contact spring elements in three dimensions, bonding of the spring sheet to an interposer substrate, and singulation of the contact elements to form a final interposer having a contact array with the arrangement determined by the customer.

A feature of this invention includes a process step during interposer fabrication to form three dimensional contact spring elements from a two dimensional spring sheet using an array of three dimensional configurable die. The terms “form” and “forming” are used herein to refer to a mechanical deformation process by which a spring sheet used to make interposer connectors is deformed at contact locations within a contact array, resulting in three dimensional features at the contact locations. In this manner, contact features patterned at the contact locations of the contact array become three dimensional contact features. In one configuration of the invention, the configurable die are ball bearings arranged in a die plate (not shown) to impart three dimensional shapes to an array of two dimensional spring elements formed from the spring element sheet. The three dimensional shapes can be imparted into the spring sheet either before or after the spring sheet is patterned to form the array of contact elements. This is accomplished within fabrication line 204 by pressing the die plate containing the configurable die against the spring element sheet by using a spring forming tool (not shown). Further details of this process are disclosed in U.S. patent application Ser. No. 10/412,729, filed Apr. 11, 2003, which is incorporated by reference herein in its entirety.

In another configuration of the invention, mask 212 is used to etch a metallic layer disposed on a semiconductor substrate (not shown) that acts as the interposer substrate. For example, an array of three dimensional surface features such as mounds or hillocks (not shown) can be fabricated on a semiconductor surface according to known methods. The mounds can be used to impart a three dimensional topography to a metallic layer subsequently deposited on the semiconductor substrate. Mask 212 can then be aligned (or “registered”) with the pattern of mounds on the semiconductor substrate, wherein the position of contact features of interposer array design 208 corresponds to positions of mounds in the semiconductor substrate. The pattern of the contact features can then be etched into the metallic layer creating, for example, a three dimensional metallic contact structure in the mound region. Subsequently, the mound material can be selectively etched leaving a metallic three dimensional contact feature attached to the semiconductor substrate in a base portion and having a free standing elastic portion in a region where the mound formerly resided. Further details of this process are disclosed in U.S. patent application Ser. No. 10/731,669, filed Dec. 8, 2003, which is incorporated by reference herein in its entirety.

Whether made on a freestanding spring sheet or a semiconductor substrate, whether three dimensional features are imparted into the metallic layer before or after patterning, fabrication of an interposer contact array of this invention is based on customer-selected contact shapes to be imparted into the interposer contacts, which are placed at customer-designated locations of the interposer contact array.

In another configuration of this invention, customer interposer (PCB) design 210 may include a customer designation of interposer substrate properties and thickness. The term interposer substrate, or carrier, is used herein to denote an electrically insulating medium such as a printed circuit board (PCB) material that retains and electrically isolates individual connectors, so that the connectors are maintained in an array. In one configuration of the invention, metal sheets containing arrays of formed spring elements (spring sheets) are then bonded with a PCB carrier in fabrication line 204.

The design details of the type and thickness of PCB carrier to be used as the substrate for the interposer are first specified by the customer using program 124 in accordance with the desired interposer properties. The design details of customer PCB design 210 can then be used by the interposer manufacturer to select a matching PCB substrate and appropriate process parameters to bond the PCB and spring sheets, as well as any plating and singulation processes used to finish fabrication of the customer-designed interposer, as explained in more detail below. In one exemplary configuration of this invention, after receiving interposer design input from program 124, mask 212 is fabricated and used in interposer fabrication line 204 in conjunction with customer-generated PCB design 210 to fabricate interposer 214.

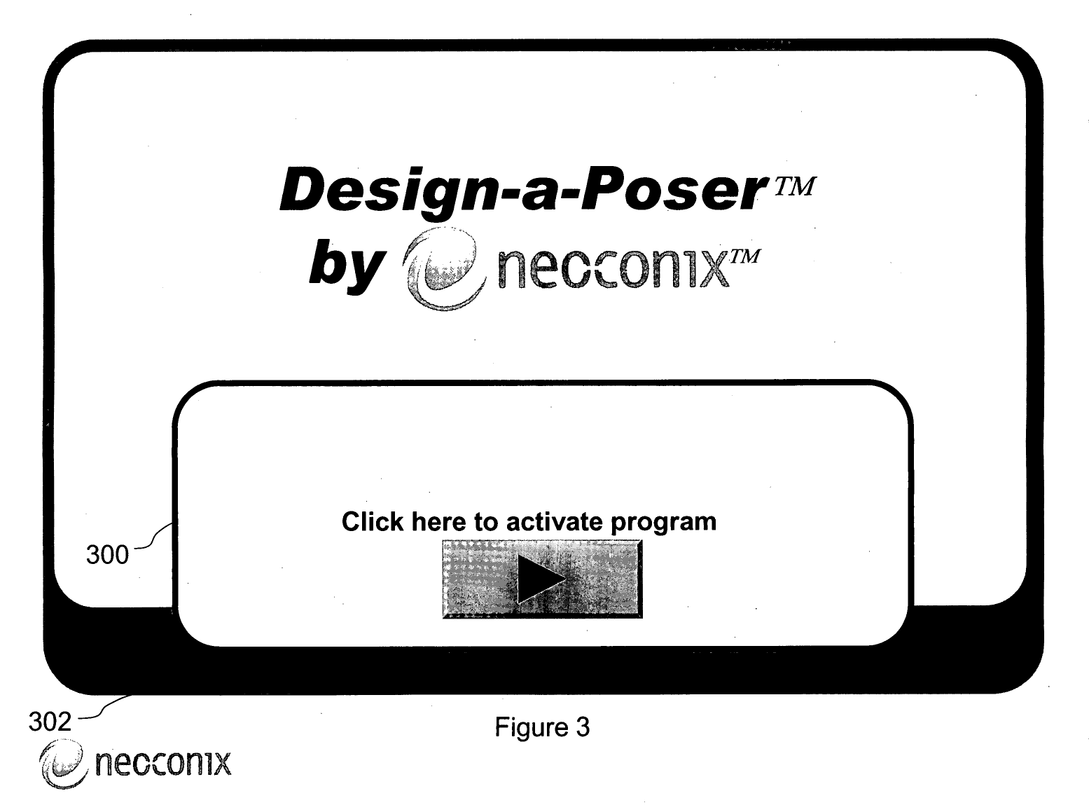

FIG. 3 illustrates features of a graphics based design program 300, arranged according to one configuration of this invention. The “Design a Poser” program 300 can be provided to a user as a stand-alone program that can be accessed using a computer or other device containing the program. In another configuration, program 300 is provided to a user accessing a website over an internet connection, which provides a web page substantially as depicted in FIG. 3. A user selecting button 302 can activate the main features of program 300. In so doing, as illustrated further below, a user can be provided with series of other pages or “screens” representing manipulable program features. These screens may exist as standalone screens within a version of program 300 that is local to the user's computer, or as a series of configurable web pages whose design content can be stored in cyberspace or at a device local to the user or interposer vendor, either temporarily or permanently.

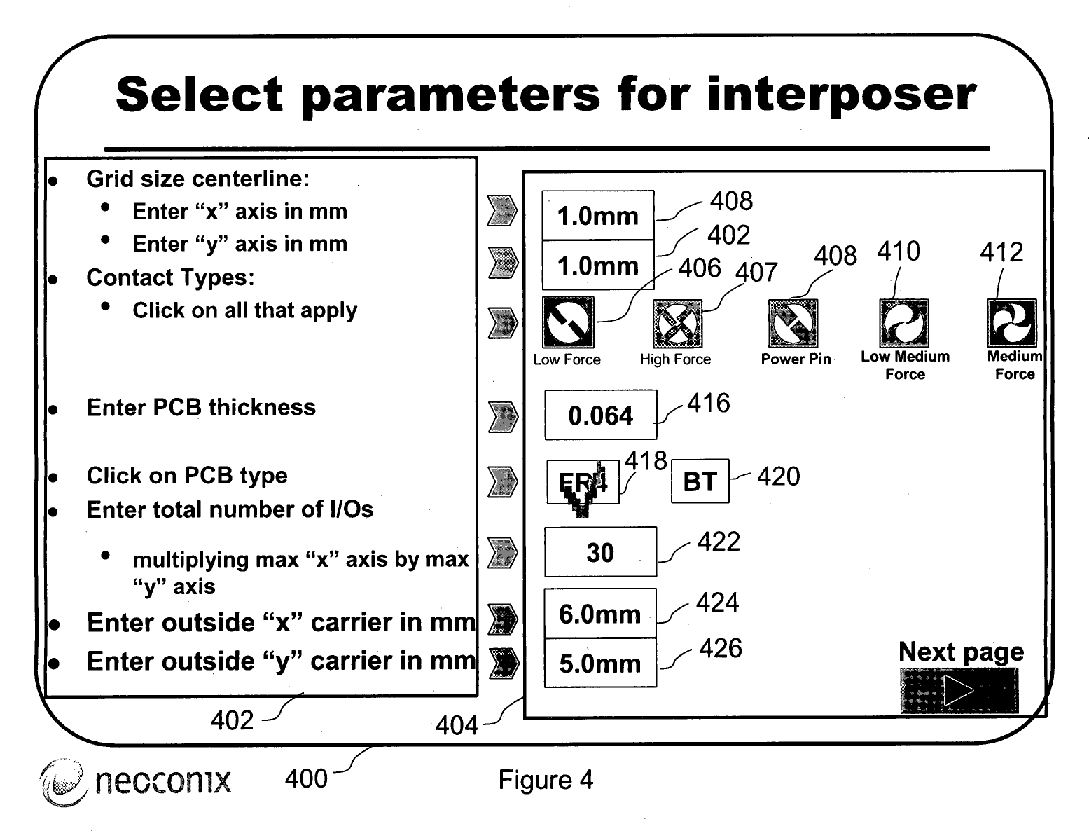

FIG. 4 illustrates an exemplary main menu 400 of program 300, according to one configuration of this invention. Menu 400 provides a set of options that allow a user to define select features of a customer-designed interposer based on a predetermined set of allowed choices for given features. Other interposer features could also be provided in menu 400. Command area 402 contains a series of prompts for user actions that can be taken in order to specify interposer features. In entry fields 403 and 405 a user can specify the x and y spacing, respectively, between nearest neighbor contact positions in a standard x-y grid array for the interposer to be designed. In the example illustrated in FIG. 4, the array spacing is 1.0 mm in both x and y direction. Preferably, program 300, in conjunction with a design library coupled thereoto, provides a predetermined set of array (or “grid”) spacing choices in the range of between about 0.5 and 1.27 mm.

In the example shown if FIG. 4, a user is prompted to select contact types for the customer-designed interposer by selecting from five different contact type icons 406-412. Each contact type associated with an icon corresponds to a different design for contact features in a contact. In one configuration of the invention, a user can select from any or all contact types to build a customer-designed interposer. In the example shown, four of the various contact types provided in the menu of FIG. 4 are denoted as differing in contact force used with the contact, which in one configuration of the invention, refers to the applied force required to achieve a given elastic deformation of the contact. For example, the “low force” contact type icon 406 may refer to a contact that deforms to a given extent, in a direction perpendicular to the plane of the contact as illustrated, under low applied force. The high force contact type icon 408 requires a relatively higher force to deform to the same extent as low force contact type icon 406. Low medium force contact type icon 410 and medium force contact type icon 412 represent contact types of intermediate deformation resistance between that represented by contact type icons 406 and 407. As illustrated, power pin icon 408 contains a design having contact arms with a relatively larger planar area than icons 406, 407, 410, and 412. Power pin icon 408 corresponds to a power pin contact that can be used to provide current to devices in the range of about 0.5 to 1.5 amps, in contrast to signal pins, which typically carry current at the milliampere or microampere level. The latter pins, correspond to contacts having shapes represented by, for example, icons 406, 407, 410, and 412.

A customer desiring to design an interposer can thus select from a range of contact elastic properties by clicking on one or more of the contact type icons provided. In this manner, actual contacts used to populate a contact array of the customer-designed interposer can be placed at differing locations within the contact array according to the desired contact properties for those differing locations. For example, a customer may determine that the desired interposer requires that a peripheral portion of the contact array includes contacts having lower contact force configuration as compared to those located in the interior of the array. Therefore, the customer may select on page 400 a low force contact 406 and a high force contact 408 from which to build her customer-designed array.

Although designated according to ease of deformation under an applied force, contact types corresponding to icons 406-412 also differ in the shape and size of contact features. Accordingly, a customer could take advantage of other shape-dependent properties besides the elastic properties in selecting different combinations of contact types from icons 406-412.

PCB thickness field 416 includes prompts for a user to input the thickness of the printed circuit board (also termed “substrate” herein) that is used to house the contacts of the interposer. Although the term printed circuit board can often be used to refer to an insulating substrate containing contacts and circuits and devices arranged therein, the term “printed circuit board thickness” or PCB thickness used herein refers to the thickness of the electrically insulating substrate portion of the interposer without any contacts or other devices situated thereon. In the example shown in FIG. 4, 0.064 inches (64 mils) is chosen as the PCB thickness. Preferably, program 300 provides a predetermined set of thickness choices over a of PCB thickness range between about 31 mils and 150 mils.

FIG. 4 also includes PCB type fields 418 and 420, which, in the configuration illustrated, are preset to “FR4” and “BT.” A user is prompted to select for the custom interposer either PCB type as illustrated. FR4 and BT are known resin types used for PCBs having relatively higher and lower coefficients of thermal expansion, respectively.

In other configurations, additional PCB types and thickness ranges could be provided as selections. For example, in one configuration of the invention, flexible insulating substrates such as Mylar or similar materials can be provided in additional PCB type fields (not shown) displayed near fields 418, 420. In the latter configuration, the range of PCB thickness choices provided in field 416 is about 0.5 mil to 10 mils. U.S. patent application Ser. No. 11/082,974, filed Mar. 18, 2005, describes details of interposer fabrication using flexible substrates and is incorporated by reference herein in its entirety.

I/O count field 422 provides a number corresponding to the maximum input output connections needed to fully connect to the contacts to be provided within the customer-designed interposer. In the configuration depicted in FIG. 4, the customer is prompted to enter the X- and Y-dimensions of the interposer array to be built. The overall (or “outside”) array dimension in the X- and Y-directions can be specified in fields 424, 426. The number of I/O connections in field 422 is 30, corresponding to an array of thirty contact positions arranged in a 6 mm by 5 mm X-Y grid having 1 mm spacings in both directions as provided in fields 403,405.

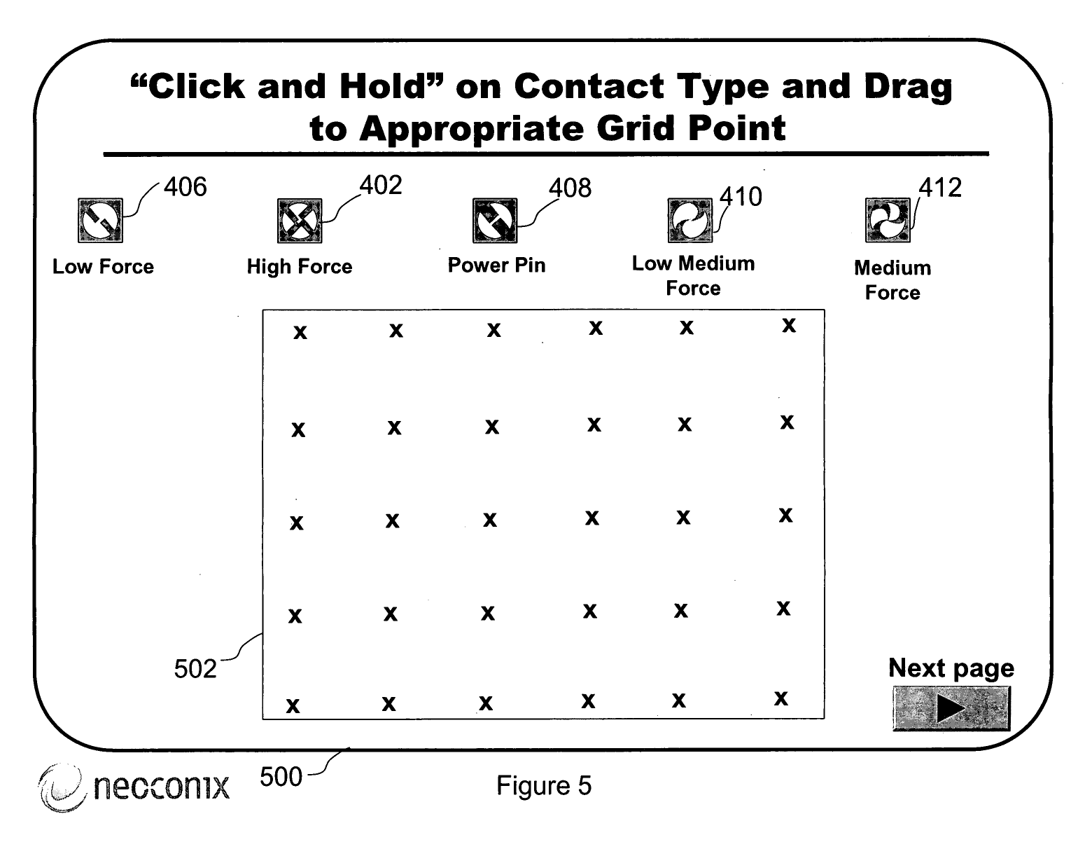

In one configuration of the invention, after entering values for parameters displayed in FIG. 4, a user is provided with an interposer layout page 500, as illustrated in FIG. 5. Page 500 also provides a series of icons of contact types 406-414, from which a user can select to populate grid area 502.

In one configuration, a user is prompted to populate at least some grid positions (denoted by ‘x’) with contact type icons. Population of grid area 502 can be performed using a drag and drop operation to manipulate contact type icons 412-414, so that contact types are associated with grid positions of grid area 502. Once a contact icon is selected and dropped at a location on grid area 502, page 500 displays the contact at that grid location.

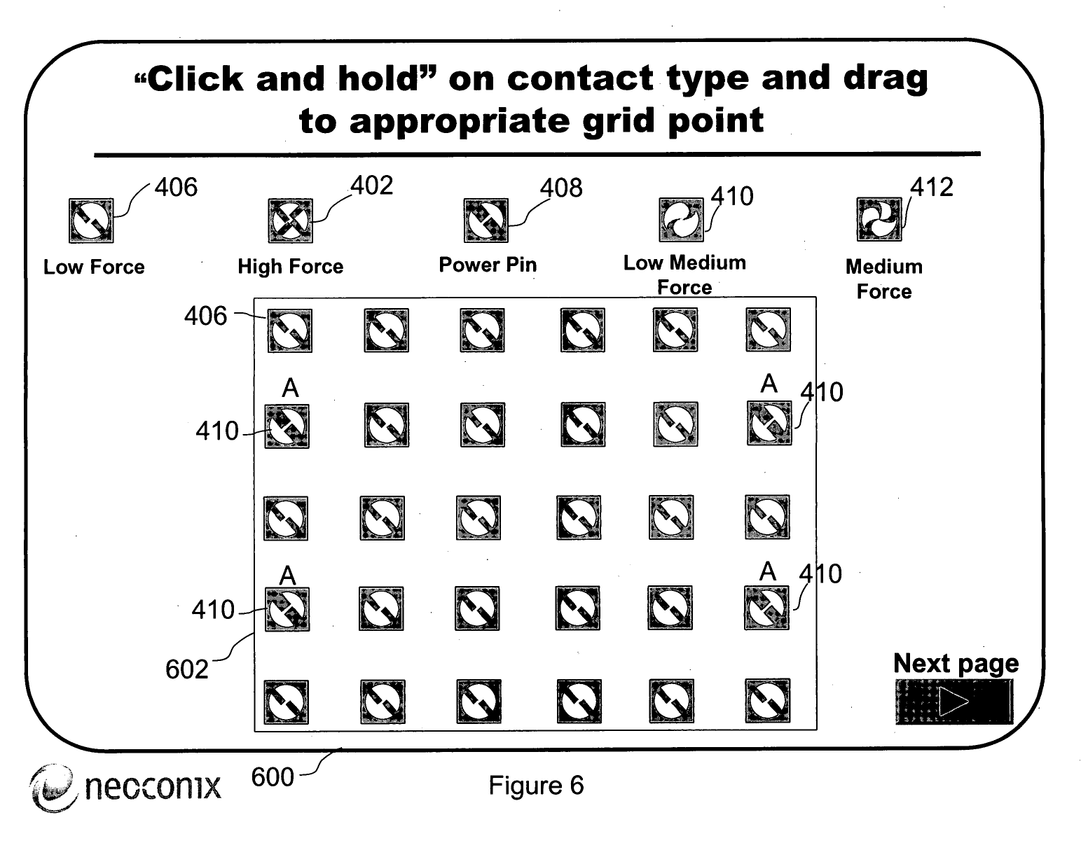

FIG. 6 illustrates page 600 that contains populated array 602 having a contact icon associated with each array position, representing a total of 30 contacts. The overall dimensions of array 602 are denoted by the “X” and “Y” brackets. An interposer contact array corresponding to the arrangement of FIG. 6 contains low force contacts at most array positions, save four positions marked “A” that lie at the periphery of the array. Positions “A” contain power pin icons 410 denoting that power pins are to be placed at such positions in the interposer being designed.

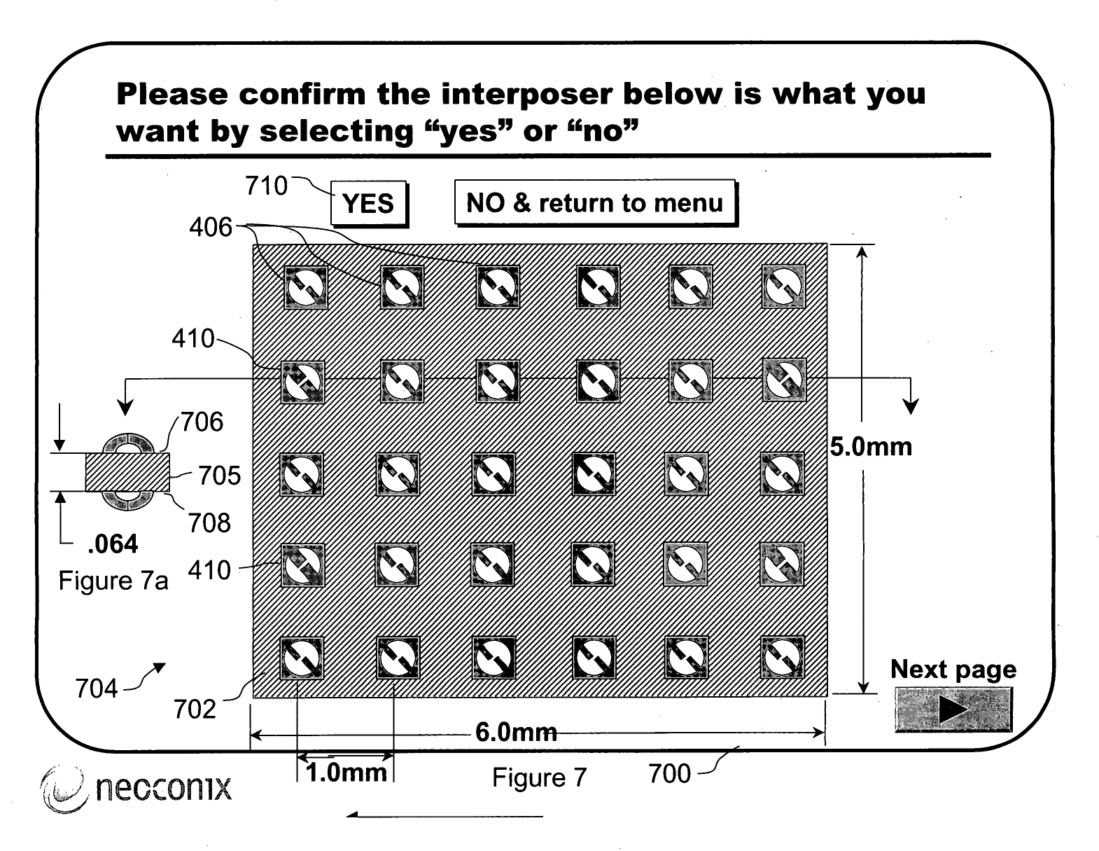

FIG. 7 illustrates a further page 700 arranged according to one configuration of this invention. PCB 702 is illustrated in plan view and cross section, having dimensions of 6.0 mm and 5.0 mm in the X and Y dimension as illustrated. In this exemplary configuration, the PCB dimensions are those entered in main menu 400 of FIG. 4. PCB 702 is illustrated together with contact icons 406, 410 located thereon, and having the same relative arrangement of the populated array 602, forming interposer drawing 704. Interposer drawing 704 provides to the customer a convenient visual representation of the arrangement of important features of the customer-designed interposer being created. The customer can check to see if the type, number and relative position of contacts are in accordance with what the customer desires.

In the configuration shown in FIG. 7, the interposer cross-sectional drawing 705 indicates that contacts are to be placed in pairs on both sides of PCB 702, so that contacts will form opposing pairs that can be connected to form a single connector that forms an electrically conductive path (not shown) from top side 706 to bottom side 708 of PCB 702. In this configuration, a user is prompted to confirm that interposer 704 is what the user wants by selecting “Yes” field 710.

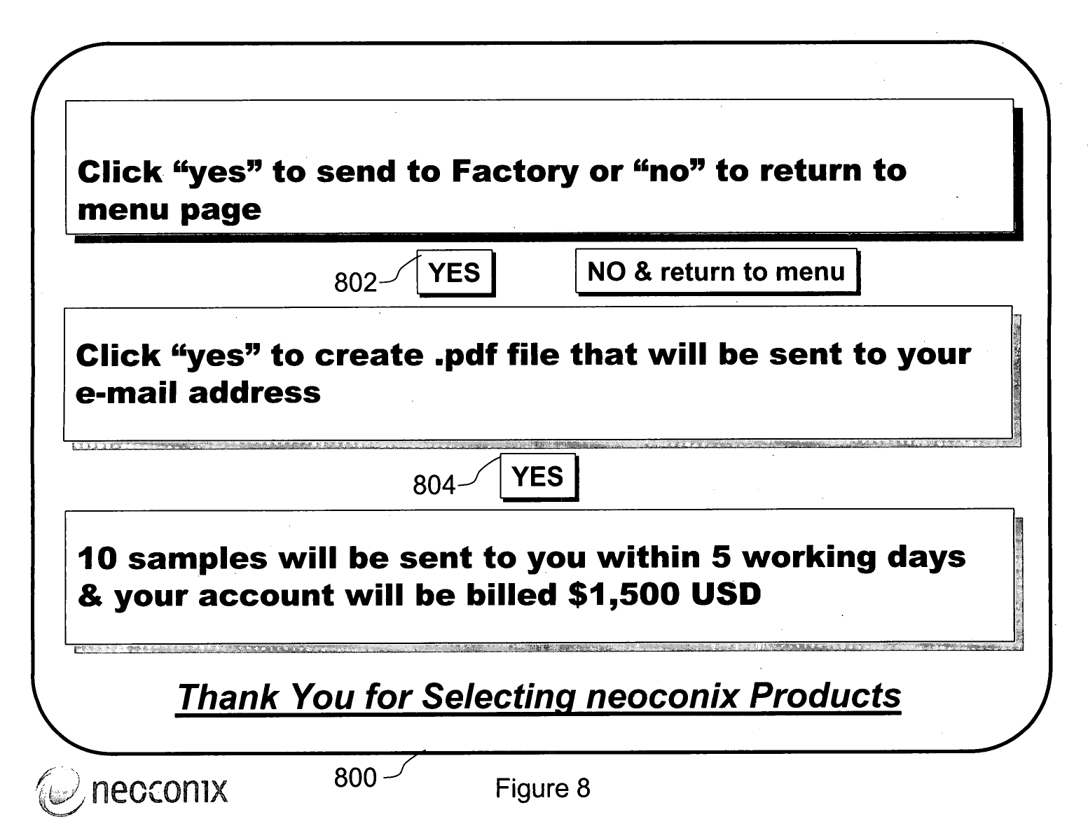

In one configuration of this invention illustrated in FIG. 8, a further menu 800 is provided that prompts a user, by selecting field 802, to forward information associated with the custom designed interposer illustrated in FIG. 7 to a vendor for fabrication of the interposer. In the example of FIG. 8, menu 800 resides as a web page linked electronically to a vendor or other entity responsible for fabrication of the customer-designed interposer. The user can also select to send a .pdf file associated with the customer designed interposer to the user's email address by selecting field 804.

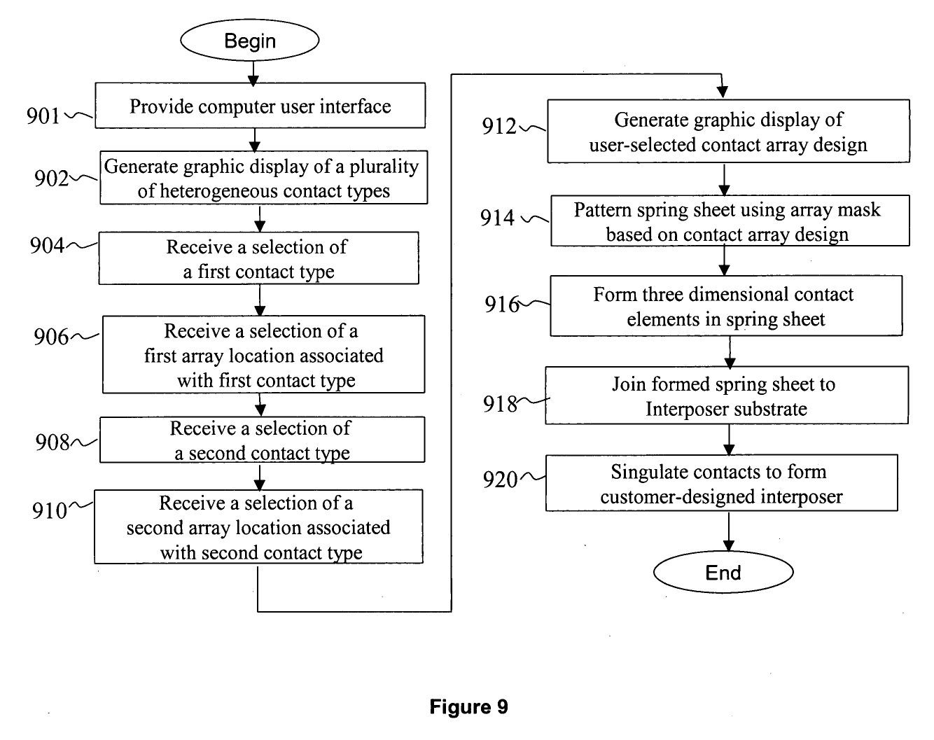

FIG. 9 illustrates a method 900 for customer-designed fabrication of an interposer according to one aspect of this invention. In step 901, a customer is provided with a computer user interface to facilitate custom design of an interposer according to the customer's needs. The user interface provides to a customer access to design parameters such as contact design that can be used to construct a customer-designed interposer.

In step 902, a display of a selection of heterogeneous contact types to be used in the customer's interposer array is generated and provided to the customer. The display of heterogeneous contact types can be, for example, on a pre-set menu of contact choices provided in a menu of a design program, as discussed above.

In step 904, a first contact type selection is received from the choices provided in the display of heterogeneous contact types. For example, a customer clicks on a first contact type icon displayed in a graphical menu and the first contact type selection is sent to a digital file that stores the information.

In step 906, a first array location selection associated with the first contact type is received. For example, a customer using a graphical design menu and a computer mouse drags an icon representing the first contact type over a graphical representation of an interposer array, and drops the icon at a position corresponding to the first array location. This array location information is then stored together with the associated contact type.

In step 908, a second contact type selection is received from the choices provided in the display of heterogeneous contact types. The second contact type corresponds to a contact design different from the first contact type. For example, a customer clicks on a second contact type icon displayed in a graphical menu and the second contact type selection is sent to a digital file that stores the information.

In step 910, a second array location selection associated with the second contact type is received. For example, a customer using a graphical design menu and a computer mouse drags an icon representing the second contact type over a graphical representation of the array, and drops the icon at a position corresponding to the second array location. This array location information is then stored together with the associated contact type.

In step 912, a display containing a contact array design is generated and provided to the customer based on the operations performed in steps 904-910. For example, a web page of a design program is displayed to a customer that contains icons representing the first and second contact designs placed at the customer-chosen locations in the contact array. The customer can then confirm that the contact array design is correct.

In step 914, a spring sheet is patterned using a customer-designed array mask based on the contact array design. In this manner, two dimensional contact elements are formed within the spring sheet.

In step 916, the contact elements are formed into three dimensions using a forming process. In one aspect, the forming process involves deforming the spring sheet having the array of contact elements by pressing a die plate that contains configurable die against the spring sheet.

In step 918, the spring sheet with three dimensional contact elements is joined with a PCB substrate.

In step 920, three dimensional contacts in the contact array of the spring sheet are singulated to form an array of electrically isolated elastic contacts joined with the PCB carrier. The resulting interposer contains the customer-designed type and arrangement of elastic contacts arranged in an array of connectors according to the customer's application.

One advantage of the above process is that an interposer having an array of heterogeneous three dimensional contacts can be fabricated based on the customer's needs. By providing a means to select the type and location of contacts within an interposer array, unique interposers closely matched to a customer's application can be fabricated in a convenient manner.

The foregoing disclosure of configurations of the present invention has been presented for purposes of illustration and description. It is not intended to be exhaustive or to limit the invention to the precise forms disclosed. Many variations and modifications of the configurations described herein will be apparent to one of ordinary skill in the art in light of the above disclosure. The scope of the invention is to be defined only by the claims appended hereto, and by their equivalents.

For example, the fabrication process for the customer-designed interposer of this invention need not take place in the same location as interposer array mask fabrication. In one example of the invention, a vendor receiving a customer-designed interposer order sends an order to a mask house to fabricate an interposer array mask based on the order. This array mask can then be used by an appropriate interposer manufacturer to make the custom designed interposer.

Additionally, as noted above an interposer array “mask” of this invention need not be embodied as a physical mask used to selectively block radiation to pattern a layer. Alternatively, a customer's mask design could be embodied in a computer program used to generate a known “direct write” lithography process, such as electron beam lithography of other direct write process in which a layer is patterned by moving a narrow beam over that layer in the pattern defined by the customer's mask design.

Further, in describing representative configurations of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. For example, although embodiments described above illustrated steps in which a user selects array grid spacings and overall array dimensions, in other embodiments those parameters can be fixed, so that a user is limited to populating a single array type with a plurality of heterogeneous contact types. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for fabricating an interposer, comprising:
generating a graphic display of a plurality of heterogeneous contact types;
receiving a first selected contact type;
receiving a first selected location at which to place the first selected contact type in a contact array;
receiving a second selected contact type that differs from the first selected contact type;
receiving a second selected location at which to place the second selected contact type in the contact array;
generating a graphic display of a contact array design having the first and second contact types placed in the respective first and second selected locations of the contact array;
patterning a contact array into a spring sheet according to the contact array design; and
forming the spring sheet at array locations within the contact array.

2. The method of claim 1, further comprising displaying the plurality of heterogeneous contact types and the contact array design on a computer user interface.

3. The method of claim 1, further comprising:
receiving a choice of an X-axis grid spacing corresponding to an X axis of the contact array design; and
receiving a choice of a Y-axis grid spacing corresponding to a Y axis of the contact array design.

4. The method of claim 3, the respective choices of X-axis and Y-axis grid spacings corresponding to a predetermined set of choices in the range of about 0.5 to 1.27 mm.

5. The method of claim 1, further comprising:
receiving a choice of an overall X dimension of the contact array design; and
receiving a choice of an overall Y dimension of the contact array design.

6. The method of claim 1, further comprising:
receiving a choice of a substrate thickness for the interposer; and
receiving a choice of substrate type for the interposer.

7. The method of claim 1, further comprising:
joining the formed spring sheet to an interposer substrate; and
singulating contacts of the spring sheet.

8. A system for fabricating an interposer, comprising:
a user interface that displays interposer design elements to a customer;
a design library that includes a predetermined set of heterogeneous contact types;
a design program linked to the user interface that prompts a customer to select interposer contact types from the predetermined set of heterogeneous contact types; and
an interposer fabrication system linked to the user interface that patterns and forms interposer contact arrays based on the customer's selection of interposer contact types.

9. The system of claim 8, the user interface comprising a computer user interface.

10. The system of claim 8, the design library further comprising:
a predetermined set of choices of interposer substrate types;
a predetermined set of choices of interposer substrate thickness; and
a predetermined set of choices for parameters for contact array design.

11. The system of claim 10, the parameters for contact array design comprising:
a predetermined set of X-axis grid spacings corresponding to an X axis of the contact array design;
a predetermined set of Y-axis grid spacings corresponding to a Y axis of the contact array design;
a predetermined set of overall X dimensions of the contact array design; and
a predetermined set of overall Y dimensions of the contact array design.

12. The system of claim 8, the design program comprising:
at least one web page displaying entry fields and icons that accept user selections; and
at least one web page that accepts and displays user placement of contact type selections in a contact array.

13. The system of claim 8, the interposer fabrication system comprising;
an interposer array mask having an interposer contact array pattern based on the customer's selection of interposer contact types; and
an interposer fabricator that patterns a metallic layer from which an array of heterogeneous contacts is fabricated using the interposer array mask.

14. The system of claim 13, the interposer array mask comprising a physical mask produced by a mask generator.

15. The system of claim 13, the interposer array mask comprising a set of data used by a direct write lithography tool to pattern a lithographically sensitive layer disposed on the metallic layer.

16. A method for fabricating an interposer, comprising:
prompting a user to select from a plurality of heterogeneous contact types;
receiving a first selected contact type;
receiving a first selected location at which to place the first selected contact type in a contact array;
receiving a second selected contact type that differs from the first selected contact type;
receiving a second selected location at which to place the second selected contact type in the contact array;
generating a graphic display of a contact array design having the first and second contact types placed in the respective first and second selected locations of the contact array; and
fabricating contacts of the first and second contact types at the respective first and second selected locations of the contact array.

17. The method of claim 16, the conductive layer comprising one of a stand alone metallic spring sheet and a metallic layer disposed on a semiconductor substrate surface that has an array of three dimensional surface features.

18. The method of claim 17, the fabricating contacts of the first and second contact types comprising:
coating the stand alone metallic spring sheet with a lithographically sensitive medium;
patterning the lithographically sensitive medium using the contact array mask;
etching contact features into the stand alone metallic spring sheet using the patterned lithographically sensitive medium; and
forming contacts in three dimensions using an array of configurable die.

19. The method of claim 17, the fabricating contacts of the first and second contact types comprising:
registering positions of the first and second contact type features in a contact array mask to positions of the array of three dimensional surface features on the semiconductor substrate;
coating the metallic layer disposed on the semiconductor substrate surface with the lithographically sensitive medium;
patterning the lithographically sensitive medium using the contact array mask; and
etching contact features into the metallic layer disposed on the semiconductor substrate surface using the patterned lithographically sensitive medium.

20. The method of claim 16, further comprising joining the metallic layer with an interposer substrate.

21. The method of claim 20, the interposer substrate being flexible and having a thickness of less than about 10 mils.
